(19) United States
(12) Patent Application Publication
(10) Pub. No.: US 2003/0023562 A1
(43) Pub. Date: Jan. 30, 2003

(54) Secure records storage and retrieval system and method

(76) Inventors: Steven Bailey, Windemere, FL (US); Robert Masson, Windemere, FL (US); John Rosemeyer, Sanford, FL (US)

Correspondence Address: JENKENS & GILCHRIST, P.C., Suite 3200, 1445 Ross Avenue, Dallas, TX, 75202-2799, US

(21) Appl. No.: 10/202,793

(22) Filed: Jul. 25, 2002

Related U.S. Application Data
(60) Provisional application No. 60/308,044, filed on Jul. 25, 2001.
(60) Provisional application No. 60/387,708, filed on Jun. 10, 2002.
(60) Provisional application No. 60/387,689, filed on Jun. 10, 2002.

(51) Int. Cl. G06F 17/60

(52) U.S. Cl. 705/51

(57) ABSTRACT

A secure records storage and retrieval system and method includes an access portal and a data vault. The data vault includes multiple customer data vaults and provider data vaults that can be used to securely store and retrieve records belonging to a particular customer or provider. Access to records contained within a given customer or provider's data vault can be authorized via an access key, which allows a provider to access records contained in the customer or provider's data vault under time or use based restrictions set by the customer. The customer or provider can also access their own records via the access portal. The access key can be set by the customer to permit access to records contained in the customer's data vault only via the access portal. The customer or provider has the ability to accept or reject records uploaded to the customer or provider's data vault and can also annotate records added the customer or provider's data vault.

### RELATED APPLICATIONS

This patent application claims priority from and incorporates by reference the entire disclosure of each of U.S. Provisional Patent Application No. 60/308,044, filed on Jul. 25, 2001, U.S. Provisional Patent Application No. 60/387,708, filed on Jun. 10, 2002, and U.S. Provisional Patent Application No. 60/387,689, filed on Jun. 10, 2002. This patent application also incorporates by reference the entire disclosure of a U.S. Provisional Patent Application entitled “Medical Records and Simulated E-mail System and Method,” filed on Jul. 25, 2002 and bearing docket no. 53218-00014.

### BACKGROUND

1. Technical Field of the Invention

The present invention relates to records systems and, more particularly, but not by way of limitation, to a method of and system for storing and retrieving medical and other records and information and providing controlled access thereto and selective delivery thereof within a communications network for convenience of records owners such as medical patients as well as others needing access to the records, such as healthcare service providers.

2. History of Related Art

Healthcare service, financial service, legal service, and other service providers must have a variety of information available to them in order to provide adequate services to their customers. In a healthcare services context, the most fundamentally important information is typically the medical history of the patient. It is therefore typical for the offices of conventional healthcare service providers to have patients fill out lengthy forms addressing a variety of subjects, including a description of the patient's prior health issues and associated treatments therefor.

Record-keeping requirements imposed on healthcare service providers raise a myriad of issues. A primary issue is the patient's ability to recall the necessary information in a short period of time while waiting in a healthcare service provider's office. A second issue is the time necessary to fill out the requisite forms. An additional issue is the level of specificity that may be necessary to provide answers necessary for the healthcare service provider to provide adequate service to the patient.

Most often, in-depth medical histories are taken by healthcare service providers (e.g., doctors) themselves. It is common for a healthcare service provider to request information about all aspects of a patient's prior medical issues, treatment, and, in particular, all medications taken in the past or being taken by a patient at the time of diagnosis or treatment. Under current systems, only in this manner can the healthcare service provider prescribe appropriate treatment and/or medication(s) without unnecessarily risking an adverse side reaction.

In some situations, it is advantageous for a first healthcare service provider to have actual copies of data, tests, and/or other diagnostic procedures performed at the office of a second healthcare service provider. Such data can include, for example, X-rays, echocardiograms (EKGs), magnetic resonance imaging (MRI) scans, as well as notes of an attending technician, doctor, or other healthcare service provider. The data is seldom available to the patient, unless the patient has been advised in advance to order and obtain the data for review by the healthcare service provider.

Not all visits to a healthcare service provider are voluntary and not all visits to a healthcare service provider are by patients who have the means to acquire in-depth medical records. Few patients can access and deliver such medical records in an organized, timely, fashion to the healthcare service provider's office as needed. It is for this reason that a system and method affording the patient the ability to easily collect, store, and transmit medical information about the patient to any healthcare service provider would present marked advantages over current approaches.

Another problem with conventional medical records systems is that most systems of this general type are healthcare-service-provider-centric rather than patient-centric. Many disadvantages flow from this fact. For example, when medical records are stored at a healthcare service provider's facility, they are, for all practical purposes, out of the control of, and availability to, the patient. Patients are often required to pay a fee in order to obtain a copy of their own medical records from the healthcare service provider or to have the healthcare service provider forward a paper copy of the medical records to another of the patient's healthcare service providers.

In addition, healthcare-service-provider-centric medical records are oftentimes not secure. For example, these records are often maintained by inexperienced hourly employees that could easily be fooled into providing an unauthorized person access to the medical records or are stored in facilities that otherwise do not have adequate security procedures in place.

Another disadvantage of healthcare-service-provider-centric medical records is that a patient that is served by more than one healthcare service provider will likely have a separate set of medical records at each healthcare service provider's office. Moreover, there is oftentimes no global copy of such a collection of different healthcare service providers' records. Thus, the different healthcare service providers must oftentimes rely upon the patient, who is almost always a relatively uneducated conduit of information, to provide information from the various medical records not located at a particular healthcare service provider's office.

Another problem associated with healthcare-service-provider-centric medical records is that the records are typically maintained in paper form and are therefore inaccessible by other healthcare service providers besides the healthcare service provider that is maintaining that particular medical record. Further, maintaining the medical records in paper form results in extra costs due to unnecessary copying and mailing of medical records as well as copying errors and other problems that result from healthcare services being provided by a healthcare service provider without the most up to date and complete information about the patient being available.

Another disadvantage to paper medical records is the risk of destruction of the records by, for example, fire or flood. Because the healthcare service provider typically maintains the only copy of a particular set of medical records for the patient, damage to or destruction of the medical records at the healthcare service provider's office typically results in an inability to recover those records.

Another problem associated with healthcare-service-provider-centric medical records is that when a third party, such as an insurance company or a lawyer, needs access to the medical records of the patient, the patient oftentimes has no access to the records or control over which of the patient's records are provided to the third party and/or what the third party does with such medical records after the third party has obtained them. Under current systems, the patient typically has no means to track the flow of information among the patient's healthcare service providers and/or third parties.

Another problem with healthcare-service-provider-centric medical records is that the records are oftentimes unavailable to emergency healthcare service providers. Medication allergies are just one example of information that emergency healthcare service providers need to know about, but often do not, when providing emergency medical services to a patient. In addition, although many documents, such as living wills, are not technically medical records, lack of access to such information by healthcare service providers in emergency situations often results in unnecessary treatment being undertaken by a healthcare service provider.

Another problem with healthcare-service-provider-centric medical records is that it is very difficult for the patient to provide selective access to portions of the patient's medical records to a healthcare-service-provider or a third party. When a medical record is requested by a third party or another healthcare service provider, all records of the patient that are maintained by the providing healthcare service provider are typically sent to the requesting party (i.e., the other healthcare service provider or third party). Thus, if the patient does not want certain portions of the medical records to be provided to the requesting party, it is extremely difficult for the patient to segregate those medical records that are to be provided from those that are not to be provided.

Another problem with healthcare-service-provider-centric medical records is the difficulty of the patient in accessing his or own medical records. The Health Insurance Portability and Accountability Act of 1996 (HIPAA) requires, among other things, that patients be permitted to annotate their medical records. Because, as noted above, these records are often maintained at many different sites and are in paper form, it is impractical for patients to exercise this right and annotate their medical records.

Many security and other concerns relative to the medical records remain even when the medical records have been put into electronic form. For example, because medical records almost always contain extremely sensitive personal information, sending them via conventional electronic mail is simply not desirable, because of the lack of control the patient has over the medical records once they have been sent electronically and because of the lack of security of conventional electronic mail.

Another problem associated with healthcare-service-provider-centric medical records is that current systems do not permit time-limited access to the medical records. Once medical records have been sent via electronic mail or as paper copies, it is extremely difficult to ensure that any time-limited access restrictions have been complied with. Another problem with current systems is the inability to verify that a medical record has actually been sent and by whom and to whom the medical record has been sent.

Although the above-mentioned problems relate to medical records, many similar problems exist with respect to other types of records, such as, for example, financial documents, legal documents, military documents, genealogical documents, insurance documents, automobile records, as well as any other types of documents or records that need to be securely maintained, tracked, accessed, and/or controlled. These types of documents and others often suffer from similar problems to those listed above in the medical-records context. Therefore, a secure records storage and retrieval system and method that eliminates the disadvantages mentioned above and other disadvantages is needed.

### SUMMARY OF THE INVENTION

The present invention relates to record systems and, more particularly, but not by way of limitation, to a method of and system for storing and retrieving medical and other records and information and providing controlled access thereto and selective delivery thereof within a communications network for convenience of records owners such as medical patients and others needing access to the records, such as healthcare service providers.

A method of providing access to a customer record located in a database includes providing, by a customer, of an access key relative to the customer record. The access key specifies at least one record-access criterion. A participant accesses the customer record via the access key. The access key can be set by the customer such that the participant can access the customer record only via an access portal linked with the database. Data relative to the record transmitted to the participant via the access portal is encrypted.

A method of providing access to a customer record located in a database includes setting an access key relative to the customer record. The access key specifies at least one record-access criterion. The access key is set such that a participant can access the customer record only via an access portal linked with the database. The method also includes providing the access key to the participant, encrypting data relative to the customer record, and transmitting the data to the participant via the access portal.

A method of obtaining access to a customer record located in a database includes receiving, by a participant, of an access key relative to the customer record. The access key specifies at least one record-access criterion. The method also includes accessing, by the participant, of the customer record via the access key. The access key can be set by the customer such that the participant can access the customer record only via an access portal linked with the database. Data relative to the record transmitted to the participant via the access portal is encrypted.

A method of selectively enabling access by a participant to a customer record located in a database includes providing an access key relative to the customer record. The access key specifies at least one record-access criterion. The method also includes receiving, by the participant, of the access key and accessing, by the participant, of the customer record via the access key. The access key can be set by the customer such that the participant can access the customer record only via an access portal linked with the database. Data relative to the record transmitted to the participant via the access portal is encrypted.

An apparatus for providing access to a customer record located in a database includes means for providing an access key relative to the customer record. The access key is adapted to specify at least one record-access criterion. The customer record is accessed via the access key. The access key is adapted to allow a customer to permit a participant to access the customer record only via an access portal linked with the database. Data relative to the record transmitted to the participant via the access portal is encrypted.

An apparatus for providing access to a customer record located in a database includes means for providing access relative to the customer record. The means for providing access is adapted to specify at least one record-access criterion. The customer record is accessed via the means for providing access. The means for providing access is adapted to allow a customer to permit a participant to access the customer record only via an access portal linked with the database. Data relative to the record transmitted to the participant via the access portal is encrypted.

An apparatus for obtaining access to a customer record located in a database includes means for receiving an access key relative to the customer record. The access key is adapted to specify at least one record-access criterion. The apparatus also includes means for accessing the customer record via the access key. The access key is adapted to allow a customer to permit a participant to access the customer record-only via an access portal linked with the database. Data relative to the record transmitted to the participant via the access portal is encrypted.

An apparatus for selectively permitting access to a customer record located in a database, includes an access key for accessing the customer record. The access key is adapted to specify at least one record-access criterion and to allow a customer to permit a participant to access the customer record only via an access portal linked with the database. The apparatus also includes means for accessing the customer record via the access key and means for encrypting data relative to the record transmitted to the participant via the access portal.

A method of adding a customer record to a customer data vault includes inputting the customer record into a database. The database includes the customer data vault. An opportunity is provided to the customer to reject the customer record and, in response to the customer not rejecting the customer record, the customer record is added to the customer data vault.

A method of adding a customer record to a customer data vault includes receiving the customer record in a database. The database includes the customer data vault. The method also includes providing an opportunity to the customer to reject the customer record and, in response to the customer not rejecting the customer record, adding the customer record to the customer data vault.

An apparatus for adding a customer record to a customer data vault includes means for inputting the customer record into a database. The database includes the customer data vault. An opportunity is provided to the customer to reject the customer record and, in response to the customer not rejecting the customer record, the customer record is added to the customer data vault.

An apparatus for adding a customer record to a customer data vault includes means for receiving the customer record in a database. The database includes the customer data vault. The apparatus also includes means for providing an opportunity to the customer to reject the customer record and means for adding the customer record to the customer data vault in response to the customer not rejecting the customer record.

A computer-readable medium has stored thereon sequences of instructions. The sequences of instructions include instructions that, when executed by a processor, cause the processor to receive a customer record into a database. The database includes a customer data vault. The processor is also caused to provide an opportunity to the customer to reject the customer record and, in response to the customer not rejecting the customer record, add the customer record to the customer data vault.

A computer-readable medium has stored thereon sequences of instructions. The sequences of instructions include instructions that, when executed by a processor, cause the processor to receive an access key relative to a customer record. The access key specifies at least one record-access criterion. The processor is also caused to permit access to the customer record via the access key, set the access key so as to permit access to the customer record only within a database, and transmit data relative to the access key outside the database in an encrypted fashion.

### BRIEF DESCRIPTION OF THE DRAWINGS

A more complete understanding of exemplary embodiments of the present invention can be achieved by reference to the following Detailed Description of Exemplary Embodiments of the Invention when taken in conjunction with the accompanying Drawings, wherein:

FIG. 1 is a block diagram of a secure records storage and retrieval system 100 in accordance with principles of the present invention;

FIG. 2 is a diagram of a record upload flow 200 in accordance with principles of the present invention;

FIG. 3 is a diagram of a customer access flow 300 in accordance with principles of the present invention;

FIG. 4 is a diagram of an emergency records access flow 400 in accordance with principles of the present invention; and

FIG. 5 is a diagram of a multiple-provider access flow 500 in accordance with principles of the present invention.

### DETAILED DESCRIPTION OF EXEMPLARY EMBODIMENTS OF THE INVENTION

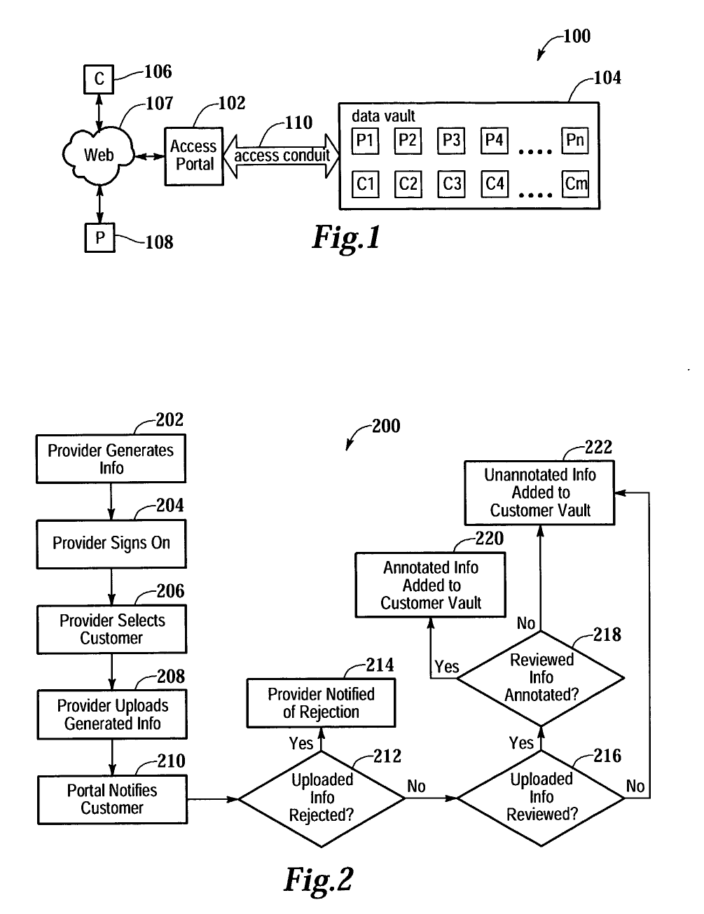

In the following Detailed Description of Exemplary Embodiments of the Invention, for purposes of explanation and not limitation, specific details are set forth in order to provide a thorough understanding of the present invention. Preferred embodiments of the present invention and its advantages are best understood by referring to FIGS. 1-5 of the Drawings. However, it will be apparent to those of ordinary skill in the art that the present invention can be practiced in other embodiments that depart from these specific details. In other instances, detailed descriptions of well-known methods, devices, logical code (e.g., hardware, software, firmware), etc. are omitted so as not obscure description of the present invention with unnecessary detail. In particular, even though examples discussed in the following Detailed Description are largely in the context of medical records, the present invention can be practiced in a wide variety of contexts, including, but not limited to, financial, legal, genealogical, automobile, real estate, and other contexts.

FIG. 1 is a block diagram of a secure records storage and retrieval system 100 in accordance with principles of the present invention. The system 100 includes an access portal 102. The access portal 102, which, in a preferred embodiment, is an Internet web portal, permits participants to have access to documents stored by the system 100. The access portal 102 can preferably be accessed globally, via, for example, a personal computer or other web-enabled device.

The system 100 also includes a data vault 104. The data vault 104, which includes at least one database for storing and retrieving records stored thereon, includes a plurality of data vaults that correspond to a plurality of participants. The data vault 104 typically includes one or more servers (including one or more processors), storage media, and input-output devices as are known to those having ordinary skill.

A participant can be either a provider or a customer. A provider is typically an entity, such as, for example, a medical doctor or other healthcare service provider, that generates records or other information on behalf of and that are owned by a customer. Data vaults P1-Pn and C1-Cm, which correspond respectively to n provider data vaults and m customer data vaults are shown within the data vault 104. Each of the data vaults P1-Pn and C1-Cm, although shown as occupying discrete portions of the data vault 104, are representative of information owned by each of the entities P1-Pn and C1-Cm, respectively, and do not necessarily represent discrete segregated physical locations of the data vault 104.

Shown interacting with the access portal 102 are a customer (C) 106 and a provider (P) 108. The customer 106 and the provider 108 can access data vaults of various participants within the data vault 104 via the access portal 102 and an access conduit 110 linking the access portal 102 and the data vault 104. The system 100 communicates with the customer 106 and the provider 108 via a communication network represented as a web cloud 107, which is, for example, the Internet.

Providers and customers, such as, for example, the provider 108 and the customer 106, access records contained in their respective data vaults via the access portal 102 and the access conduit 110 and can access records contained on other participants' data vaults via an access key provided by the participant that is the owner of the particular data vault to be accessed.

In a preferred embodiment of the present invention, a graphical user interface viewable via the access portal 102 includes what appears to be a conventional electronic mail (e-mail) system and is therefore sometimes referred to as a simulated e-mail system. In a preferred embodiment, when a first participant desires to allow a second participant to access records contained in the first participant's data vault, the first participant sends, within the system 100, an access key to the second participant. Upon signing on to the system 100 via the access portal 102, the second participant preferably sees an icon representative of the access key that can be activated by the second participant to access the record or records denoted therein by the first participant.

The first participant can predetermine various access criteria, such as those based upon time of access and actions that can be taken relative to the records corresponding to the access key. For example, the first participant could designate that only a particular provider could access certain records but not others, that those records to be accessed could only be accessed for a period of two days, and/or that no printing of the records be allowed.

FIG. 2 is a diagram of a record upload flow 200 in accordance with principles of the present invention. The flow 200 begins at step 202, wherein a provider, such as, for example, a healthcare service provider, generates information relative to a customer, such as, for example, a patient of the healthcare service provider. The generated information could be the result of, for example, a visit by the patient to the office of the healthcare service provider. At step 204, the provider signs on to the access portal 102. At step 206, the provider selects a data vault of the customer. At step 208, the provider uploads the generated information into the data vault of the customer selected at step 206. In a preferred embodiment of the present invention, the step of uploading the generated information occurs via the access portal 102.

At step 210, the access portal 102 notifies the customer that information has been uploaded to the data vault of the customer. Notification of the customer is, in a preferred embodiment, via the customer signing on to the access portal 102 and receiving a simulated e-mail message that indicates that information has been uploaded by the provider to the data vault of the customer. Notification of the customer can also be via, for example, conventional e-mail.

From step 210, execution proceeds to step 212. At step 212, the customer can reject or accept the information uploaded by the provider. If the customer rejects the uploaded information, at step 214, the provider is notified of the rejection and the uploaded information is not made a part of the data vault of the customer. If, at step 212, the uploaded information is not rejected by the customer, execution proceeds to step 216.

At step 216, the customer has an opportunity to review the uploaded information. If the customer reviews the uploaded information at step 216, at step 218, the customer has an opportunity to annotate the reviewed information. If the customer reviews the annotated information at step 218, at step 220, the annotated information is added to the data vault of the customer. If, at step 216, the uploaded information is not reviewed or if at step 218, the reviewed information is not annotated, execution proceeds to step 222. At step 222, the unannotated information is added to the data vault of the customer.

In a preferred embodiment of the present invention, a provider, after having generated information relative to a customer, such as, for example, an MRI scan, uploads the MRI scan of the customer to a data vault of the customer located in the data vault 104. The data vault of the customer is representative of documents and other information relative to the customer and controlled by the customer that are located in the data vault 104. No person other than the customer can access or control information contained in the customer's data vault without the customer's authorization. The extent to which any information located in the customer's data vault is made accessible to any other person, including any provider, is within the sole discretion and control of the customer.

In a preferred embodiment of the present invention, upon uploading of the generated information by the provider to the customer's data vault, the customer is notoifed via the access portal 102 of the upload of the information. This notification can be, for example, by conventional e-mail.

Upon receipt of the conventional e-mail message, the customer can log onto the access portal 102, which can be, for example, a website. Upon signing onto the access portal 102, the customer preferably encounters a simulated e-mail system that permits the customer to determine whether the information uploaded by the provider is to be rejected and therefore not included within the customer's data vault or accepted into the customer's data vault. If the customer decides to reject the information uploaded by the provider, the provider would, in a preferred embodiment, be notified via simulated e-mail on the access portal 102 or via conventional e-mail.

In a preferred embodiment, the customer can then review the uploaded information by clicking on a folder or other icon of a graphical user interface on the access portal 102. In a preferred embodiment, the icon of the access portal 102 resembles conventional e-mail, although documents within the data vault 104 are not actually moved or transmitted but are rather accessed from their current location within the data vault 104. After reviewing the uploaded information, the patient can, in a preferred embodiment, annotate the reviewed information by typing a note into a pre-defined field linked to the uploaded information. Thereafter, the annotated or unannotated information uploaded by the provider can be added to the customer's data vault. When the uploaded information is later accessed, encryption is preferably used to access the document from outside the access portal 104 and hashing algorithms can be used to provide further security.

The simulated e-mail system within the system 100 preferably includes a participant-type attribute valued to indicate whether the participant is a provider or a customer. A value of the participant-type attribute indicates whether additional profile information is retained in a customer or a provider data vault (e.g., database table). Super-type and sub-type tables are preferably utilized within a structure of the data vault 102.

The data vault 102 is adapted to permit establishment of relationships that a given participant can have with another participant. The relationships among participants are substantiated via parallel relationship to a structured database table. The simulated e-mail system builds upon the super-type and allows database applications to easily establish personal and business relationships that a given participant has with other participants.

The data vault 102 is adapted to allow participants to define a plurality of roles that the participant performs, such as, for example, doctor or patient. Recognition that customers have roles allows the customers to retain a single sign-on and also indicates daily interactions that the customers face. Participant relationships are used to govern the roles and to direct the simulated e-mail messages.

Table constructs are used to build a simulated e-mail interaction queue and utilize the parallel relationships from different participants within the subject of the simulated e-mail message. Since the simulated e-mail messages normally require a response, a recursive relationship is used to create an audit trail from one simulated e-mail message to another simulated e-mail message.

The data vault 102 is adapted to allow the participants to attach their medical and personal documents to a simulated e-mail message. The attachment to the simulated e-mail message is actually an internal link to an access key, which ensures that the participant's documents are securely protected.

FIG. 3 is a diagram of a customer access flow 300 in accordance with principles of the present invention. The flow 300 begins at step 302, wherein the customer signs onto the access portal 102. At step 304, the customer transmits an access key to another participant, such as a provider. The access key permits the participant to access, under certain conditions, particular records located in the data vault of the customer. These conditions can include, for example, time-based restrictions, as well as use-based restrictions. Examples of use-based restrictions are read-only, no-print, and no-save restrictions.

At step 306, the participant (e.g., provider) signs onto the access portal 102. Following sign on, at step 308, the participant (e.g., provider) is able to access the particular customer records via the access key.

From step 308, execution proceeds to step 310. At step 310, a determination is made whether the customer has denied access to the particular records since the access key was transmitted. If it is determined at step 310 that the customer has denied access, at step 312 execution ends and the participant (e.g., provider) is no longer allowed access to the particular records. If, however, the customer has not denied access at step 310, execution returns to step 308 and the participant (e.g., provider) is allowed continued access to the particular records.

An example including operation of the flow 300 would be a patient that wants to make an appointment with a neurosurgeon following an appointment with the patient's primary care doctor. The patient can contact the neurosurgeon via a message sent the access portal 102 and provide an access key to whichever documents using or other information from the patient's data vault that the patient wants the neurosurgeon to be able to access. Any use or time based restrictions that the patient wants to impose upon the information provided to the neurosurgeon can also be determined at this time. The access key and the message sent via the access portal 102 are then provided to the neurosurgeon so that, when the neurosurgeon signs onto the access portal 102, the message and the access key from the patient will be displayed to the neurosurgeon (or the neurosurgeon's assistant or other designee). The message to the neurosurgeon and the access key are both transmitted and received within the confines of the system 100 such that any information transmitted outside the system 100 is encrypted and therefore protected from access by unauthorized persons. By activating the access key, the neurosurgeon (or assistant or other designee) can access the documents contained within the patient's data vault until the patient denies access to those records or a pre-defined restriction renders the access no longer valid.

Although the above example pertains to a patient providing access to particular records for, for example, a limited period of time to the patient's neurosurgeon, a patient can also pre-authorize trusted persons, such as, for example, a primary care doctor, to access any documents contained in the patient's data vault that have not been restricted from access to the trusted person by the customer. Irrespective of what restrictions are or are not placed on access to documents contained in a customer's data vault, the customer retains complete control over the restrictions placed on an access to the documents contained in the customer's data vault.

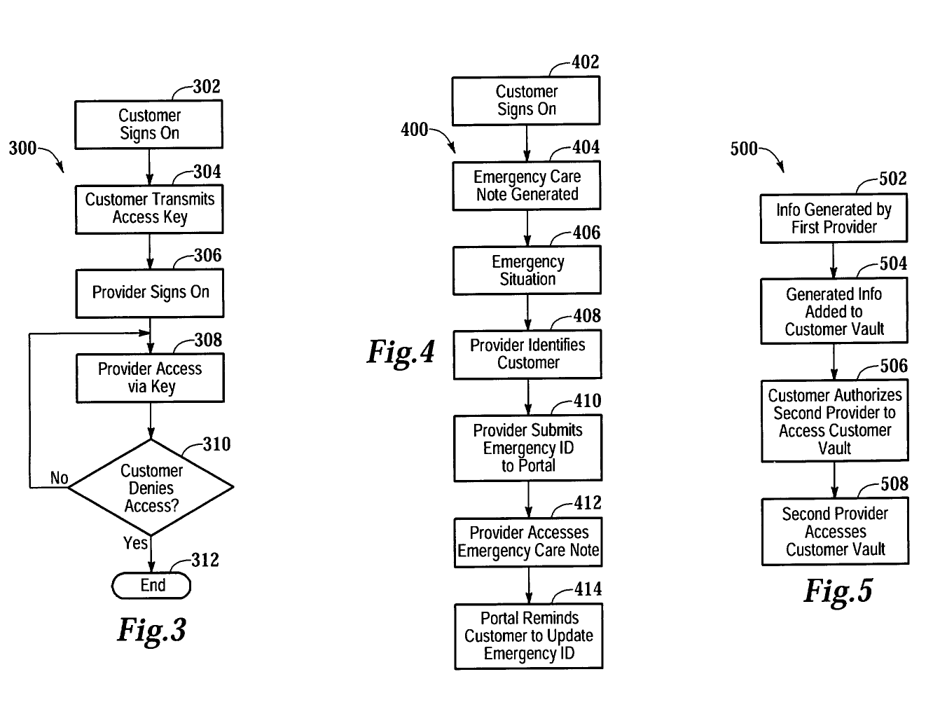

FIG. 4 is a diagram of an emergency records access flow 400 in accordance with principles of the present invention. The flow 400 begins at step 402, wherein the customer signs onto the access portal 102. At step 404, the customer generates an emergency care note to be accessed by emergency healthcare service providers in the event of an emergency situation involving the customer and also generates an emergency identification number that serves as an access key to the emergency care note. At step 406, an emergency situation, such as an automobile accident, occurs. From step 406, execution proceeds to step 408.

At step 408, the emergency healthcare service provider identifies the customer via, for example, biometric information, a card carried by the patient, a bracelet, or the like. In a preferred embodiment, the identification of the customer includes identification by the emergency healthcare service provider of the emergency identification number relative to the customer and the customer's emergency care note.

At step 410, the emergency healthcare service provider submits the emergency identification to the access portal 102, which permits the emergency healthcare service provider to access the emergency care note generated by the customer at step 404 and stored in the customer's data vault. At step 412, the emergency healthcare service provider accesses the emergency care note. At step 414, the access portal 102 reminds the customer to update the emergency identification in order to guard against future unauthorized accesses of the emergency care note.

In a preferred embodiment of the present invention, the customer populates an emergency care data structure in connection with step 404 so that key questions will be accessible by emergency healthcare providers in the event of an emergency situation involving the customer. In a preferred embodiment, an emergency medical service vehicle with wireless access or an emergency room signs on to the access portal 102 as an emergency care provider in connection with step 408 and then inputs the emergency identification pertinent to the customer.

The emergency identification opens the data vault of the customer, but preferably permits only particular information that has been pre-designated by the customer to be accessed via the emergency identification. For example, the emergency care note could include basic demographic information, medications, health conditions not marked as confidential, previous surgeries not marked as confidential, and any preferences regarding healthcare service providers to be used or not used, and hospital of choice, etc. The emergency care note could also include whether the patient is an organ donor, the patient's blood type, as well as any other information that might be helpful to an emergency healthcare service provider.

FIG. 5 is a diagram of a multiple-provider access flow 500 in accordance with principles of the present invention. The flow 500 begins at step 502. At step 502, information is generated by a first provider relative to a customer. At step 504, the generated information is added to the data vault of the customer. At step 506, the customer authorizes a second provider to access the data vault of the customer. At step 508, the second provider accesses the data vault of the customer.

Because the customer makes the rules that govern all uses of information contained in the customer's data vault, the customer might, for example, want his cardiologist and his cardiothoracic surgeon to both access an echocardiogram (EKG) that was done at a local hospital. Therefore, in accordance with a preferred embodiment of the present invention, the customer can provide an access key to both his cardiologist as well as his cardiothoracic surgeon and enable them to access the EKG in accordance with the customer's desires. As noted above, pre-designation of persons permitted to access particular records can be given by the customer.

In preferred embodiments of the present invention, more than one provider can access the EKG at the same time, since the EKG is within the database of the access portal and is not actually transmitted, copied, or moved during an access but is instead read from a single location. An example of an entity given such pre-designation could be the customer's insurance company or health maintenance organization, in addition to a primary care doctor of the customer.

The data vault can also be used to store and access various other types of documents and records. For example, child-identifying information can be stored in a customer's data vault in order to locate a lost or abducted child. Private, controlled connectivity to the child-identifying information by law enforcement agencies could be authorized by, for example, the lost child's parents.

In a preferred embodiment, the child-identifying information includes digital photographs of the child, biometric information, a copy of the child's DNA, in a form consistent with law enforcement and FBI missing-persons questionnaires.

An implant certificate can also be stored on the customer's data vault. The implant certificate includes a digital representation of an image of a medical implant and superimposes the image on a digital document. The superimposition allows a doctor to attest to authenticity of the digital representation. The digital representation may be coupled with a digital certificate to prove authenticity and for the purpose of alerting interested parties that an individual has a medical implant. Verification of authenticity can be used, for example, for purposes of security screening. A document can preferably be accessed worldwide via the access portal 102 and printed as a legal representation of the document.

A customer's data vault can also be used to store and analyze genetic information based on pre-existing genetic screens and external genetic testing. Alerts and recommendations can be provided to the customer based on national screening criteria. The genetic information can be made available to customers so that the customers can be screened for disease prior to contracting them. A customer's data vault can also be used to give the customer the ability to store and access documents and software applications in the event of a disaster or theft.

Although some of the examples discussed above are in the context of a provider accessing a customer's records, it should be understood that the present invention encompasses any participant authorizing any other participant to access records. In addition, although embodiment(s) of the present invention have been illustrated in the accompanying Drawings and described in the foregoing Detailed Description, it will be understood that the present invention is not limited to the embodiment(s) disclosed, but is capable of numerous rearrangements, modifications, and substitutions without departing from the invention defined by the following claims.

What is claimed is:

1. A method of providing access to a customer record located in a database, the method comprising:
providing, by a customer, of an access key relative to the customer record, the access key specifying at least one record-access criterion;
wherein a participant accesses the customer record via the access key;
wherein the access key can be set by the customer such that the participant can access the customer record only via an access portal linked with the database; and
wherein data relative to the record transmitted to the participant via the access portal is encrypted.

2. The method of claim 1, wherein the access key prevents the participant from moving or copying the customer record to a location outside a data vault that includes the database.

3. The method of claim 2, wherein the participant is a healthcare service provider.

4. The method of claim 1, wherein the at least one record-access criterion comprises at least one of a time based criterion and a use based criterion.

5. The method of claim 4, wherein the access key is provided via a simulated e-mail system.

6. A method of providing access to a customer record located in a database, the method comprising:
setting an access key relative to the customer record, the access key specifying at least one record-access criterion, the access key being set such that a participant can access the customer record only via an access portal linked with the database;
providing the access key to the participant;
encrypting data relative to the customer record; and
transmitting the data to the participant via the access portal.

7. The method of claim 6, wherein the access key prevents the participant from moving or copying the customer record to a location outside a data vault that includes the database.

8. The method of claim 7, wherein the participant is a healthcare service provider.

9. The method of claim 6, wherein the at least one record-access criterion comprises at least one of a time based criterion and a use based criterion.

10. The method of claim 9, wherein the access key is provided via a simulated e-mail system.

11. A method of obtaining access to a customer record located in a database, the method comprising:
receiving, by a participant, of an access key relative to the customer record, the access key specifying at least one record-access criterion;
accessing, by the participant, of the customer record via the access key;
wherein the access key can be set by the customer such that the participant can access the customer record only via an access portal linked with the database; and
wherein data relative to the record transmitted to the participant via the access portal is encrypted.

12. The method of claim 11, wherein the access key prevents the participant from moving or copying the customer record to a location outside a data vault that includes the database.

13. The method of claim 12, wherein the participant is a healthcare service provider.

14. The method of claim 11, wherein the at least one record-access criterion comprises at least one of a time based criterion and a use based criterion.

15. The method of claim 14, wherein the access key is provided via a simulated e-mail system.

16. A method of selectively enabling access by a participant to a customer record located in a database, the method comprising:
providing an access key relative to the customer record, the access key specifying at least one record-access criterion;
receiving, by the participant, of the access key;
accessing, by the participant, of the customer record via the access key;
wherein the access key can be set by the customer such that the participant can access the customer record only via an access portal linked with the database; and
wherein data relative to the record transmitted to the participant via the access portal is encrypted.

17. The method of claim 16, wherein the access key prevents the participant from moving or copying the customer record to a location outside a data vault that includes the database.

18. The method of claim 17, wherein the participant is a healthcare service provider.

19. The method of claim 16, wherein the at least one record-access criterion comprises at least one of a time based criterion and a use based criterion.

20. The method of claim 19, wherein the access key is provided via a simulated e-mail system.

21. An apparatus for providing access to a customer record located in a database, the apparatus comprising:
means for providing an access key relative to the customer record, the access key being adapted to specify at least one record-access criterion;
wherein the customer record is accessed via the access key;
wherein the access key is adapted to allow a customer to permit a participant to access the customer record only via an access portal linked with the database; and
wherein data relative to the record transmitted to the participant via the access portal is encrypted.

22. The apparatus of claim 21, wherein the access key prevents the participant from moving or copying the customer record to a location outside a data vault that includes the database.

23. The apparatus of claim 22, wherein the participant is a healthcare service provider.

24. The apparatus of claim 21, wherein the at least one record-access criterion comprises at least one of a time based criterion and a use based criterion.

25. The apparatus of claim 24, wherein the means for providing comprises a simulated e-mail system.

26. An apparatus for providing access to a customer record located in a database, the apparatus comprising:
means for providing access relative to the customer record, the means for providing access being adapted to specify at least one record-access criterion;
wherein the customer record is accessed via the means for providing access;
wherein the means for providing access is adapted to allow a customer to permit a participant to access the customer record only via an access portal linked with the database; and
wherein data relative to the record transmitted to the participant via the access portal is encrypted.

27. The apparatus of claim 26, wherein the means for providing access comprises an access key.

28. The apparatus of claim 27, wherein the access key prevents the participant from moving or copying the customer record to a location outside a data vault that includes the database.

29. The apparatus of claim 26, wherein the participant is a healthcare service provider.

30. The apparatus of claim 26, wherein the at least one record-access criterion comprises at least one of a time based criterion and a use based criterion.

31. The apparatus of claim 30, wherein the means for providing comprises a simulated e-mail system.

32. An apparatus for obtaining access to a customer record located in a database, the apparatus comprising:
means for receiving an access key relative to the customer record, the access key being adapted to specify at least one record-access criterion;
means for accessing the customer record via the access key;
wherein the access key is adapted to allow a customer to permit a participant to access the customer record only via an access portal linked with the database; and
wherein data relative to the record transmitted to the participant via the access portal is encrypted.

33. The apparatus of claim 32, wherein the access key prevents the participant from moving or copying the customer record to a location outside a data vault that includes the database.

34. The apparatus of claim 33, wherein the participant is a healthcare service provider.

35. The apparatus of claim 32, wherein the at least one record-access criterion comprises at least one of a time based criterion and a use based criterion.

36. The apparatus of claim 35, wherein the means for receiving comprises a simulated e-mail system.

37. An apparatus for selectively permitting access to a customer record located in a database, the apparatus comprising:
an access key for accessing the customer record, the access key being adapted to specify at least one record-access criterion and to allow a customer to permit a participant to access the customer record only via an access portal linked with the database;
means for accessing the customer record via the access key; and
means for encrypting data relative to the record transmitted to the participant via the access portal.

38. The apparatus of claim 37, wherein the access key prevents the participant from moving or copying the customer record to a location outside a data vault that includes the database.

39. The apparatus of claim 38, wherein the participant is a healthcare service provider.

40. The apparatus of claim 37, wherein the at least one record-access criterion comprises at least one of a time based criterion and a use based criterion.

41. The apparatus of claim 40, wherein the means for accessing comprises a simulated e-mail system.

42. A method of adding a customer record to a customer data vault, the method comprising:
inputting the customer record into a database, the database including the customer data vault;
wherein an opportunity is provided to the customer to reject the customer record; and
wherein, in response to the customer not rejecting the customer record, the customer record is added to the customer data vault.

43. The method of claim 42, further comprising, in response to the customer rejecting the customer record, receiving notification that the customer has rejected the customer record.

44. The method of claim 42, wherein the step of inputting is performed by a healthcare service provider.

45. The method of claim 42, wherein the step of inputting comprises uploading the customer record via a secure access portal.

46. The method of claim 42, further comprising selecting a customer to which the customer record belongs.

47. The method of claim 42, wherein, following the step of inputting, a customer is notified that the step of inputting has occurred.

48. The method of claim 47, wherein the notice to the customer is via a simulated e-mail system.

49. The method of claim 42, wherein the customer record is in electronic form.

50. A method of adding a customer record to a customer data vault, the method comprising:
receiving the customer record in a database, the database including the customer data vault;
providing an opportunity to the customer to reject the customer record; and
in response to the customer not rejecting the customer record, adding the customer record to the customer data vault.

51. The method of claim 50, further comprising, in response to the customer rejecting the customer record, providing notification that the customer has rejected the customer record.

52. The method of claim 50, wherein the customer record is received from a healthcare service provider.

53. The method of claim 50, wherein the step of receiving comprises receiving an upload of the customer record via a secure access portal.

54. The method of claim 50, further comprising receiving a selection of a customer to which the customer record belongs.

55. The method of claim 50, wherein, following the step of receiving, notifying a customer that the step of receiving has occurred.

56. The method of claim 55, wherein the step of notifying is performed via a simulated e-mail system.

57. The method of claim 50, wherein the customer record is in electronic form.

58. An apparatus for adding a customer record to a customer data vault, the apparatus comprising:
means for inputting the customer record into a database, the database including the customer data vault;
wherein an opportunity is provided to the customer to reject the customer record; and
wherein, in response to the customer not rejecting the customer record, the customer record is added to the customer data vault.

59. The apparatus of claim 58, wherein, in response to the customer rejecting the customer record, notification that the customer has rejected the customer record is received.

60. The apparatus of claim 58, wherein a healthcare service provider utilizes the means for inputting.

61. The apparatus of claim 58, wherein the means for inputting comprises a secure access portal.

62. The apparatus of claim 58, further comprising means for selecting a customer to which the customer record belongs.

63. The apparatus of claim 58, further comprising means for notifying a customer that input of the customer record has occurred.

64. The apparatus of claim 63, wherein the means for notifying comprises a simulated e-mail system.

65. The apparatus of claim 58, wherein the customer record is in electronic form.

66. An apparatus for adding a customer record to a customer data vault, the apparatus comprising:
means for receiving the customer record in a database, the database including the customer data vault;
means for providing an opportunity to the customer to reject the customer record; and
means for adding the customer record to the customer data vault in response to the customer not rejecting the customer record.

67. The apparatus of claim 66, further comprising means for notifying that the customer has rejected the customer record in response to the customer rejecting the customer record.

68. The apparatus of claim 66, wherein the customer record is received from a healthcare service provider.

69. The apparatus of claim 66, wherein the means for receiving comprises a secure access portal.

70. The apparatus of claim 66, further comprising means for receiving a selection of a customer to which the customer record belongs.

71. The apparatus of claim 66, further comprising means for notifying a customer that the customer record has been received.

72. The apparatus of claim 71, wherein the means for notifying comprises a simulated e-mail system.

73. The apparatus of claim 66, wherein the customer record is in electronic form.

74. A computer-readable medium having stored thereon sequences of instructions, the sequences of instructions including instructions that, when executed by a processor, cause the processor to:
receive a customer record into a database, the database including a customer data vault;
provide an opportunity to the customer to reject the customer record; and
in response to the customer not rejecting the customer record, add the customer record to the customer data vault.

75. The medium of claim 74, further comprising sequences of instructions, the sequences of instructions including instructions that, when executed by a processor, cause the processor to notifying that the customer has rejected the customer record in response to the customer rejecting the customer record.

76. The medium of claim 74, further comprising sequences of instructions, the sequences of instructions including instructions that, when executed by a processor, cause the processor to receive a selection of a customer to which the customer record belongs.

77. The medium of claim 74, further comprising sequences of instructions, the sequences of instructions including instructions that, when executed by a processor, cause the processor to notify a customer that the customer record has been received.

78. A computer-readable medium having stored thereon sequences of instructions, the sequences of instructions including instructions that, when executed by a processor, cause the processor to:
receive an access key relative to a customer record, the access key specifying at least one record-access criterion;
permit access to the customer record via the access key;
set the access key so as to permit access to the customer record only within a database; and
transmit data relative to the access key outside the database in an encrypted fashion.

79. The medium of claim 78, wherein the access key prevents the participant from moving or copying the customer record to a location outside a data vault that includes the database.

80. The method of claim 78, wherein the at least one record-access criterion comprises at least one of a time based criterion and a use based criterion.

81. The method of claim 78, wherein the access key is provided via a simulated e-mail system.
